(19) United States
(12) Patent Application Publication
(10) Pub. No.: US 2025/0229531 A1
(43) Pub. Date: Jul. 17, 2025

(54) LIQUID JET HEAD AND LIQUID JET RECORDING APPARATUS

(71) Applicant: SII Printek Inc., Chiba-shi (JP)

(72) Inventors: Akihiro ITAGI, Chiba-shi (JP); Kensuke YOSHIDA, Chiba-shi (JP)

(21) Appl. No.: 19/016,844

(22) Filed: Jan. 10, 2025

(30) Foreign Application Priority Data
Jan. 17, 2024 (JP) 2024-005522

(51) Int. Cl. B41J 2/14; B41J 29/377

(52) U.S. Cl. CPC B41J 2/14201; B41J 29/377; B41J 2002/14491

(57) ABSTRACT

A liquid jet head and so on capable of improving the reliability are provided. A liquid jet head according to an embodiment of the present disclosure includes a jet section including a plurality of nozzles configured to jet a liquid, a drive board having a first surface on which a single drive device or a plurality of drive devices for outputting a drive signal for jetting the liquid from the nozzles to the jet section is disposed, a heat radiation member which is disposed at the first surface side in the drive board, and which is configured to cool the drive device, a pressing member which is disposed at a second surface side opposed to the first surface in the drive board, and which is configured to press the drive board against the heat radiation member, and a fixation part configured to fix a part of the pressing member to the drive board. An arrangement area of the drive device extends along a first direction in the first surface, and the fixation part is disposed in a region along a second direction perpendicular to the first direction in the first surface with reference to an arrangement position of the drive device.

### RELATED APPLICATIONS

This application claims priority to Japanese Patent application No. JP2024-005522, filed on Jan. 17, 2024, the entire content of which is incorporated herein by reference.

### BACKGROUND OF THE INVENTION

### 1. Field of the Invention

The present disclosure relates to a liquid jet head and a liquid jet recording apparatus.

### 2. Description of the Related Art

Liquid jet recording apparatuses equipped with liquid jet heads are used in a variety of fields, and a variety of types of liquid jet heads are developed.

In such liquid jet heads, in general, it is required to easily improve the reliability.

Therefore, it is desirable to provide a flexible board, a liquid jet head, and a liquid jet recording apparatus capable of easily improving the reliability.

### SUMMARY OF THE INVENTION

A liquid jet head according to an embodiment of the present disclosure includes a jet section including a plurality of nozzles configured to jet a liquid, a drive board having a first surface on which a single drive device or a plurality of drive devices for outputting a drive signal for jetting the liquid from the nozzles to the jet section is disposed, a heat radiation member which is disposed at the first surface side in the drive board, and which is configured to cool the drive device, a pressing member which is disposed at a second surface side opposed to the first surface in the drive board, and which is configured to press the drive board against the heat radiation member, and a fixation part configured to fix a part of the pressing member to the drive board. An arrangement area of the drive device extends along a first direction in the first surface, and the fixation part is disposed in a region along a second direction perpendicular to the first direction in the first surface with reference to an arrangement position of the drive device.

A liquid jet recording apparatus according to an embodiment of the present disclosure includes the liquid jet head according to the embodiment of the present disclosure.

According to the liquid jet head and the liquid jet recording apparatus related to an embodiment of the disclosure, it becomes possible to enhance the reliability.

### BRIEF DESCRIPTION OF THE DRAWINGS

FIG. 1 is a block diagram showing an outline configuration example of a liquid jet recording apparatus according to an embodiment of the present disclosure.

FIG. 2 is a perspective view schematically showing an outline configuration example of a liquid jet head shown in FIG. 1.

FIG. 3 is a cross-sectional view schematically showing a configuration example of the liquid jet head shown in FIG. 2.

FIG. 4 is a plan view schematically showing a detailed configuration example of flexible boards shown in FIG. 2 and FIG. 3.

FIG. 5 is a plan view schematically showing a detailed configuration example in the vicinity of the flexible boards shown in FIG. 4.

FIG. 6 is an exploded perspective view schematically showing a configuration example in the vicinity of the flexible board shown in FIG. 5.

FIG. 7 is a perspective view schematically showing an arrangement configuration example of a fixation part and so on shown in FIG. 6.

FIG. 8 is a plan view schematically showing an arrangement configuration example of the fixation part and so on shown in FIG. 6.

FIG. 9 is another plan view schematically showing an arrangement configuration example of the fixation part and so on shown in FIG. 6.

FIG. 10 is a schematic plan view for explaining a configuration example around drive devices.

FIG. 11 is a plan view schematically showing a detailed configuration around the drive device shown in FIG. 10.

FIG. 12 is a plan view schematically showing a configuration example in the vicinity of a flexible board related to a comparative example.

FIG. 13 is a plan view schematically showing a configuration example in the vicinity of a flexible board related to Modified Example 1.

FIG. 14 is a plan view schematically showing a configuration example in the vicinity of a flexible board related to Modified Example 2.

### DETAILED DESCRIPTION OF THE INVENTION

An embodiment of the present disclosure will hereinafter be described in detail with reference to the drawings. It should be noted that the description will be presented in the following order.
1. Embodiment (an example of a liquid jet head provided with a fixation part for a variety of constituents)
2. Modified Examples
Modified Examples 1, 2 (configuration examples when changing the number of drive devices)
3. Other Modified Examples

### 1. EMBODIMENT

### [Outline Configuration of Printer 5]

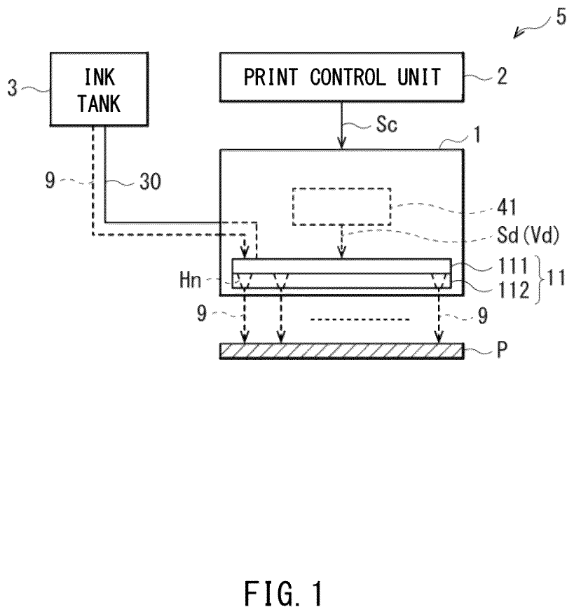

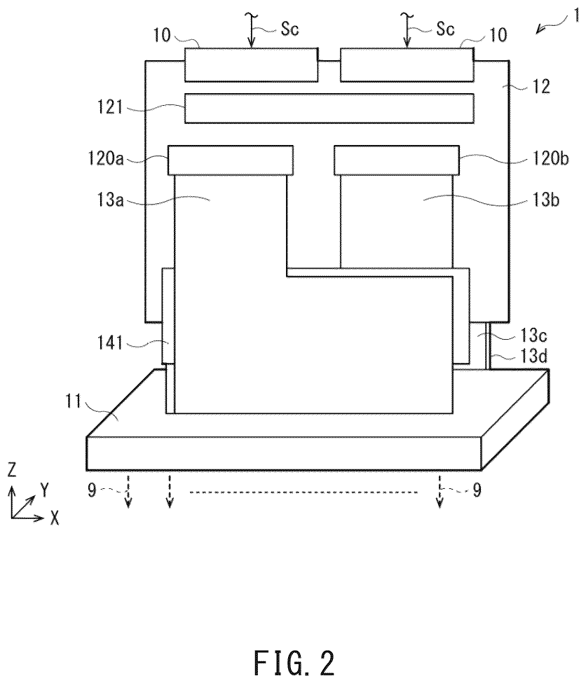

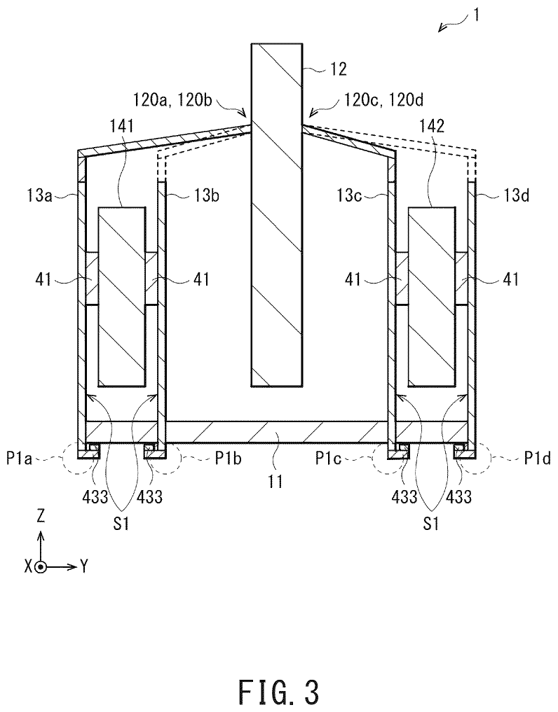

FIG. 1 is a block diagram showing an outline configuration example of a printer 5 as a liquid jet recording apparatus according to an embodiment of the present disclosure. FIG. 2 is a perspective view schematically showing an outline configuration example of an inkjet head 1 as a liquid jet head shown in FIG. 1. FIG. 3 is a cross-sectional view (a Y-Z cross-sectional view) schematically showing a configuration example of the inkjet head 1 shown in FIG. 2.

It should be noted that a scale size of each of the members is accordingly altered so that the member is shown in a recognizable size in the drawings used in the description of the present specification.

The printer 5 is an inkjet printer for performing recording (printing) of images, characters, and the like on a recording target medium (e.g., recording paper P shown in FIG. 1) using ink 9 described later. As shown in FIG. 1, the printer 5 is provided with the inkjet head 1, a print control unit 2, and an ink tank 3.

It should be noted that the inkjet head 1 corresponds to a specific example of a “liquid jet head” in the present disclosure, and the printer 5 corresponds to a specific example of a “liquid jet recording apparatus” in the present disclosure. Further, the ink 9 corresponds to a specific example of a “liquid” in the present disclosure.

### (A. Print Control Unit 2)

The print control unit 2 is for supplying the inkjet head 1 with a variety of types of information (data). Specifically, as shown in FIG. 1, the print control unit 2 is arranged to supply each of constituents (drive devices 41 described later and so on) in the inkjet head 1 with a print control signal Sc. It should be noted that the print control signal Sc is arranged to include, for example, image data, an ejection timing signal, and a power-supply voltage for making the inkjet head 1 operate.

### (B. Ink Tank 3)

The ink tanks 3 are tanks for containing the ink 9 inside. As shown in FIG. 1, it is arranged that the ink 9 in the ink tank 3 is supplied to the inside (a jet section 11 described later) of the inkjet head 1 via an ink supply tube 30. It should be noted that such an ink supply tube 30 is formed of, for example, a flexible hose having flexibility.

### (C. Inkjet Head 1)

The inkjet head 1 is a head for jetting (ejecting) the ink 9 shaped like a droplet from a plurality of nozzle holes Hn described later to the recording paper P as represented by dotted arrows in FIG. 1 to thereby perform recording of images, characters, and so on. As shown in, for example, FIG. 2 and FIG. 3, the inkjet head 1 is provided with a single jet section 11, a single I/F (interface) board 12, four flexible boards 13a, 13b, 13c, and 13d, and two cooling units 141, 142.

Here, the flexible boards 13a, 13b, 13c, and 13d (flexible boards 13 described later) each correspond to a specific example of a “drive board” in the present disclosure. Further, the cooling units 141, 142 (cooling units 14 described later) each correspond to a specific example of a “heat radiation member” in the present disclosure.

### (C-1. I/F Board 12)

As shown in FIG. 2 and FIG. 3, the I/F board 12 is provided with two connectors 10, four connectors 120a, 120b, 120c, and 120d, and a circuit arrangement area 121.

As shown in FIG. 2, the connectors 10 are each a part (a connector part) for inputting the print control signal Sc which is described above, and which is supplied from the print control unit 2 toward the inkjet head 1 (the flexible boards 13a, 13b, 13c, and 13d described later).

The connectors 120a, 120b, 120c, and 120d are parts (connector parts) for electrically coupling the I/F board 12 and the flexible boards 13a, 13b, 13c, and 13d, respectively.

The circuit arrangement area 121 is an area where a variety of circuits are arranged on the I/F board 12. It should be noted that it is also possible to arrange that such a circuit arrangement area is also disposed in other regions on the I/F board 12.

### (C-2. Jet Section 11)

As shown in FIG. 1, the jet section 11 is a part which has the plurality of nozzle holes Hn, and which jets the ink 9 from these nozzle holes Hn. It is arranged that such jet of the ink 9 is performed in accordance with drive signals Sd (drive voltages Vd) supplied from the drive devices 41 described later on each of the flexible boards 13a, 13b, 13c, and 13d (see FIG. 1).

As shown in FIG. 1, such a jet section 11 is configured including an actuator plate 111 and a nozzle plate 112.

### (Nozzle Plate 112)

The nozzle plate 112 is a plate formed of a film material such as polyimide, or a metal material, and has the plurality of nozzle holes Hn described above as shown in FIG. 1. These nozzle holes Hn are formed side by side at predetermined intervals, and each have, for example, a circular shape. It should be noted that these nozzle holes Hn each correspond to a specific example of a “nozzle” in the present disclosure.

Specifically, in the example of the jet section 11 shown in FIG. 2, the jet section 11 is configured with a plurality of nozzle arrays (four nozzle arrays) each of which has the plurality of nozzle holes Hn in the nozzle plate 112 arranged along an array direction (an X-axis direction). Further, these four nozzle arrays are arranged side by side along a direction (a Y-axis direction) perpendicular to the array direction.

### (Actuator Plate 111)

The actuator plate 111 is a plate formed of a piezoelectric material such as PZT (lead zirconate titanate). The actuator plate 111 is provided with a plurality of channels (pressure chambers). These channels are each a part for applying pressure to the ink 9, and are arranged side by side so as to be parallel to each other at predetermined intervals. Each of the channels is partitioned with drive walls (not shown) formed of a piezoelectric body, and forms a groove part having a recessed shape in a cross-sectional view.

As such channels, there exist ejection channels for ejecting the ink 9, and dummy channels (non-ejection channels) which do not eject the ink 9. In other words, it is arranged that the ejection channels are filled with the ink 9 on the one hand, but the dummy channels are not filled with the ink 9 on the other hand. It should be noted that it is arranged that filling of each of the ejection channels with the ink 9 is performed via, for example, a flow channel (a common flow channel) commonly communicated with such ejection channels. Further, it is arranged that each of the ejection channels is individually communicated with the nozzle hole Hn in the nozzle plate 112 on the one hand, but each of the dummy channels is not communicated with the nozzle hole Hn on the other hand. These ejection channels and dummy channels are alternately arranged side by side along the array direction (the X-axis direction) described above.

Further, on the inner side surfaces opposed to each other in the drive walls described above, there are respectively disposed drive electrodes. As the drive electrodes, there exist common electrodes disposed on the inner side surfaces facing the ejection channels, and active electrodes (individual electrodes) disposed on the inner side surfaces facing the dummy channels. These drive electrodes and the drive devices 41 described later are electrically coupled to each other via each of the flexible boards 13a, 13b, 13c, and 13d. Thus, it is arranged that the drive voltages Vd (the drive signals Sd) described above are applied to the drive electrodes from the drive devices 41 via each of the flexible boards 13a, 13b, 13c, and 13d (see FIG. 1).

### (C-3. Flexible Boards 13a, 13b, 13c, and 13d)

The flexible boards 13a, 13b, 13c, and 13d are each a board (a drive board) for electrically coupling the I/F board 12 and the jet section 11 to each other as shown in FIG. 2 and FIG. 3. These flexible boards 13a, 13b, 13c, and 13d are arranged to individually control jet actions of the ink 9 in the four nozzle arrays in the nozzle plate 112 described above, respectively. Further, as indicated by the reference symbols P1a, P1b, P1c, and P1d in, for example, FIG. 3, it is arranged that the flexible boards 13a, 13b, 13c, and 13d are folded around places (around pressure-bonding electrodes 433) where the flexible boards 13a, 13b, 13c, and 13d are coupled to the jet section 11, respectively. It should be noted that it is arranged that electrical coupling between the pressure-bonding electrodes 433 and the jet section 11 is achieved by, for example, thermocompression bonding using an anisotropic conductive film (ACF).

On each of such flexible boards 13a, 13b, 13c, and 13d (on an obverse surface S1), there are individually mounted the drive devices 41 (see FIG. 3). These drive devices 41 are each a device for outputting the drive signals Sd (the drive voltages Vd) for jetting the ink 9 from the nozzle holes Hn in the corresponding nozzle array in the jet section 11. Therefore, it is arranged that such drive signals Sd are output from each of the flexible boards 13a, 13b, 13c, and 13d to the jet section 11. It should be noted that such drive devices 41 are each formed of, for example, an application specific integrated circuit (ASIC).

Further, these drive devices 41 are arranged to be cooled by the cooling units 141, 142 described above. Specifically, as shown in FIG. 3, the cooling unit 141 is fixedly arranged between the drive devices 41 on the flexible boards 13a, 13b, and by pressing the cooling unit 141 against each of these drive devices 41, the drive devices 41 are cooled. Similarly, the cooling unit 142 is fixedly arranged between the drive devices 41 on the flexible boards 13c, 13d, and by pressing the cooling unit 142 against each of these drive devices 41, the drive devices 41 are cooled. It should be noted that such cooling units 141, 142 can each be configured using a variety of types of cooling mechanisms, and as an example, the cooling mechanism is configured by making a liquid such as ink flow therethrough.

[Detailed Configuration of Vicinity of Flexible Boards 13a, 13b, 13c, and 13d]

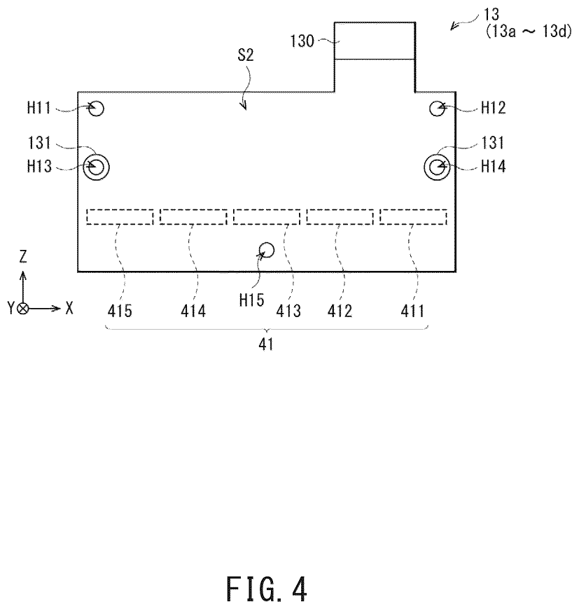

Subsequently, a detailed configuration example in the vicinity of the flexible boards 13a, 13b, 13c, and 13d described above in the inkjet head 1 will be described with reference to FIG. 4 to FIG. 11 in addition to FIG. 1 to FIG. 3.

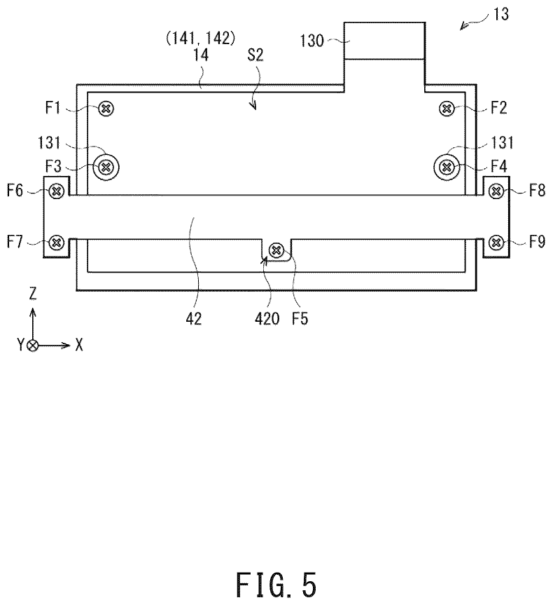

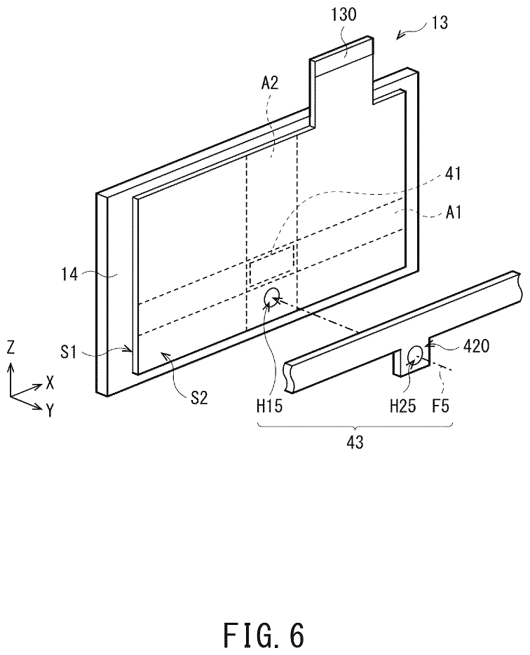

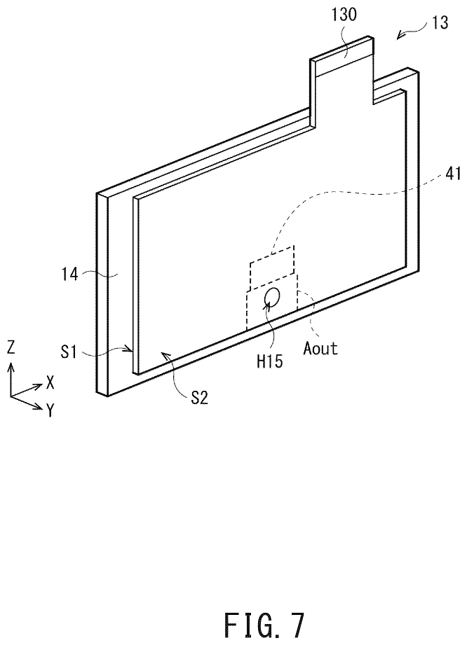

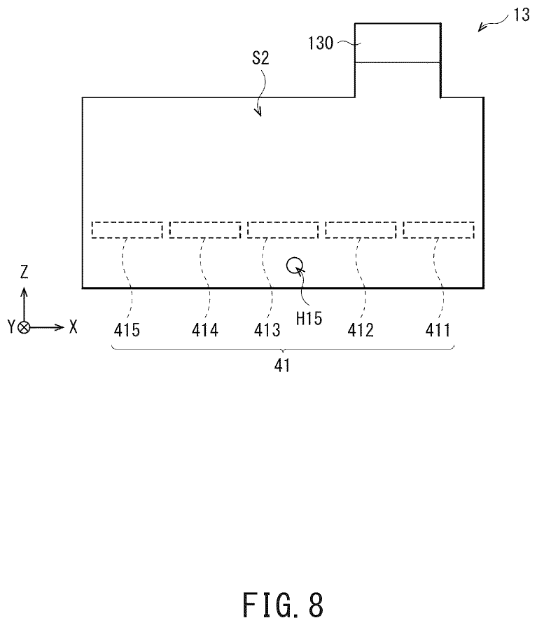

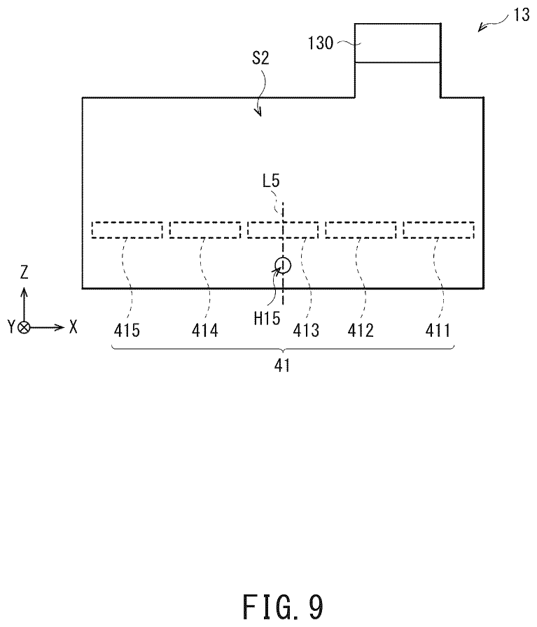

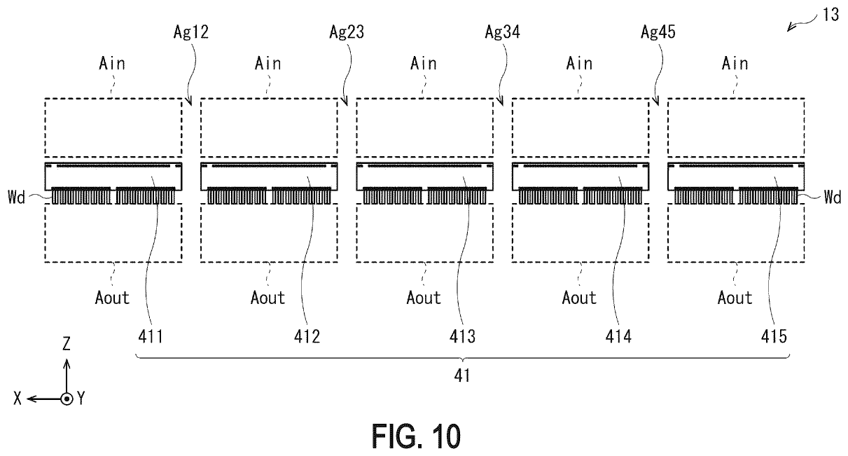

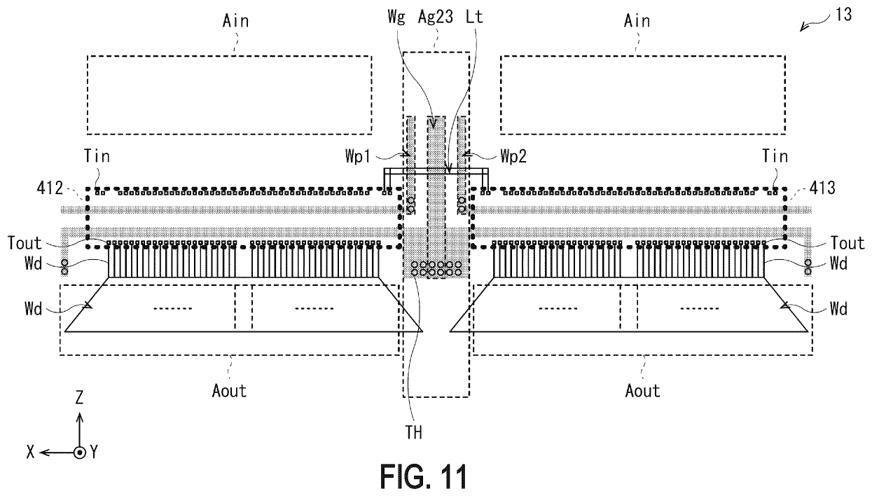

FIG. 4 is a plan view (a Z-X plan view) schematically showing a detailed configuration example of the flexible boards 13a to 13d (hereinafter collectively referred to as flexible boards 13 as appropriate) shown in FIG. 2 and FIG. 3. FIG. 5 is a plan view (a Z-X plan view) schematically showing a detailed configuration example in the vicinity of the flexible boards 13 shown in FIG. 4. Further, FIG. 6 is an exploded perspective view schematically showing a configuration example in the vicinity of the flexible boards 13 shown in FIG. 5. FIG. 7 is a perspective view schematically showing an arrangement configuration example of a fixation part 43 (described later) and so on shown in FIG. 6. FIG. 8 and FIG. 9 are each a plan view (a Z-X plan view) schematically showing an arrangement configuration example of the fixation part 43 and so on shown in FIG. 6. Further, FIG. 10 and FIG. 11 are each a plan view (a Z-X plan view) schematically showing a configuration example around the drive devices 41 on the flexible board 13. It should be noted that in each of FIG. 6 and FIG. 7, one of the plurality of drive devices 41 described later is only shown as a representative for the sake of convenience. Further, in each of FIG. 6 to FIG. 9, one of the plurality of through holes H11 to H15 described later is only shown as a representative for the sake of convenience.

First, the flexible boards 13 are each formed as a double-sided board with a multilayered structure including the obverse surface S1 and a reverse surface S2. Specifically, the flexible boards 13 each have a first wiring layer at the obverse surface S1 side and a second wiring layer at the reverse surface S2 side opposed to each other along a direction (the Y-axis direction) perpendicular to a board surface (a Z-X plane) as wiring layers having such a multilayered structure (a double-layered structure) (see FIG. 3 to FIG. 9). It should be noted that it is possible to adopt a structure in which the wiring layers in the flexible board 13 are, for example, three or more layers including the first wiring layer and the second wiring layer described above.

Here, the obverse surface S1 described above corresponds to a specific example of a “first surface” in the present disclosure, and the reverse surface S2 described above corresponds to a specific example of a “second surface” in the present disclosure.

Further, as shown in FIG. 4 to FIG. 9, the flexible boards 13 each have a single drive device 41 or a plurality of drive devices 41 (five drive devices 411 to 415 in this example) described above, a plurality of through holes H11 to H15, a terminal section 130, and a plurality of electrical contact parts 131. Further, as shown in FIG. 5 to FIG. 7, the cooling unit 141, 142 (hereinafter collectively referred to as a cooling unit 14 as appropriate) described above, a pressing member 42, and screws F1 to F9 are disposed in the vicinity of each of the flexible boards 13 in the inkjet head 1.

As described above, the drive devices 41 are disposed on (the first wiring layer at the obverse surface S1 side of) the flexible board 13. Specifically, as shown in, for example, FIG. 6, a first region A1 as an arrangement region of the drive devices 41 extends along the X-axis direction on the obverse surface S1 of the flexible board 13. Further, in the example shown in FIG. 4, and FIG. 8 to FIG. 11, the plurality of drive devices 41 (the five drive devices 411 to 415 in this example) are arranged side by side along the X-axis direction (the longitudinal direction of the flexible board 13) on the obverse surface S1 (in the first region A1 described above) of the flexible board 13.

The terminal section 130 is arranged (see FIG. 4 to FIG. 9) in an end-portion region at the I/F board 12 side in the flexible board 13, and includes a plurality of terminals for electrically coupling the flexible board 13 and the I/F board 12 to each other. In other words, the terminal section 130 is a portion to be inserted into one of the connectors 120a to 120d on the I/F board 12 as another board.

The through holes H11 to H15 are each a through hole disposed on the flexible board 13. Specifically, as shown in FIG. 4, the through holes H11, H12 are disposed in the vicinity of both end portions along the Z-axis direction in the vicinity of end portions at the terminal section 130 side along the Z-axis direction. The through holes H13, H14 are disposed in the vicinity of both end portions along the Z-axis direction in the vicinity of the center along the Z-axis direction. Further, as shown in FIG. 4 and FIG. 6, the through hole H15 is disposed in a region (a second region A2) along the Z-axis direction in the obverse surface S1 of the flexible board 13 with reference to the arrangement position of the drive devices 41. It should be noted that a detailed example of the position of this through hole H15 will be described later.

As shown in FIG. 4 and FIG. 5, the electrical contact parts 131 are members which are respectively disposed around the through holes H13, H14 in order to ensure electrical contact between the flexible board 13 and the screws F3, F4 described later. Such electrical contact parts 131 are formed using a conductive member such as a copper foil. It should be noted that as shown in FIG. 4, such electrical contact parts 131 (members for ensuring electrical contact between the flexible board 13 and the screws F1, F2, and F5 described later) are not disposed in the peripheries of the through holes H11, H12, and H15, respectively.

As described above, the cooling unit 14 (141, 143) is a member (heat radiation member) which is disposed at the obverse surface S1 side of the flexible board 13 (see FIG. 5 to FIG. 7) in order to cool the drive devices 41. Further, as shown in FIG. 5, by the screws F1 to F4 described later being inserted into the through holes H11 to H14, respectively, the flexible board 13 is fixed to the cooling unit 14. Further, although described later in detail, as shown in FIG. 5 and FIG. 6, by the screw F5 described later being inserted into the through hole H15 via the pressing member 42 described later, the flexible board 13 and the pressing member 42 are fixed to the cooling unit 14. It should be noted that a heat transfer sheet (not shown), for example, is disposed between such a cooling unit 14 and the drive devices 41, and it is arranged that the cooling unit 14 and the drive devices 41 have thermal contact with each other via the heat transfer sheet.

As shown in FIG. 5, the pressing member 42 is a member which is disposed at the reverse surface S2 side of the flexible board 13, and which presses the flexible board 13 against the cooling unit 14. As shown in, for example, FIG. 5, the pressing member 42 is fixed by being screwed to another metal member (not shown) in the vicinity of both end portions along the X-axis direction using the screws F6 to F9 described later. Further, as shown in FIG. 4 and FIG. 5, the pressing member 42 is disposed so as to cover the arrangement region (the first region A1 shown in FIG. 6) of the drive devices 41. A through hole H25 is disposed in a fixation area 420 (a protruding portion along the Z-axis direction) shown in, for example, FIG. 5 on such a pressing member 42 (see FIG. 6). It should be noted that the arrangement position of the fixation area 420 (the through hole H25) on the pressing member 42 is not limited to the example shown in FIG. 5 and FIG. 6, but may be other arrangement positions.

The screws F1 to F9 are each a member for fixing (fixing with screwing) a variety of members to each other in such a manner as described above. In particular, as shown in, for example, FIG. 6, the screw F5 for fixing the flexible board 13 and the pressing member 42 to each other is inserted into each of the through hole H15 on the flexible board 13 and the through hole H25 on the pressing member 42. Further, this screw F5 is also inserted on the cooling unit 14, and it is arranged that the force of the pressing member 42 pressing the drive devices 41 (e.g., the drive device 413) against the cooling unit 14 in the fixation area 420 is kept by this screw F5.

### (Fixation Part 43)

Here, as shown in, for example, FIG. 6, in the inkjet head 1 according to the present embodiment, the fixation part 43 is configured including the through holes H15, H25 and the screw F5 described above. As described above, this fixation part 43 is a mechanism which fixes a part (the vicinity of the fixation area 420) of the pressing member 42 to the flexible board 13. Although described later in detail, as shown in, for example, FIG. 6, such a fixation part 43 is disposed in the region (the second region A2) along the Z-axis direction perpendicular to the X-axis direction in the obverse surface S1 of the flexible board 13 with reference to the arrangement position of the drive devices 41.

The reason that such a fixation part 43 is disposed in the inkjet head 1 according to the present embodiment will hereinafter be described with reference to a comparative example.

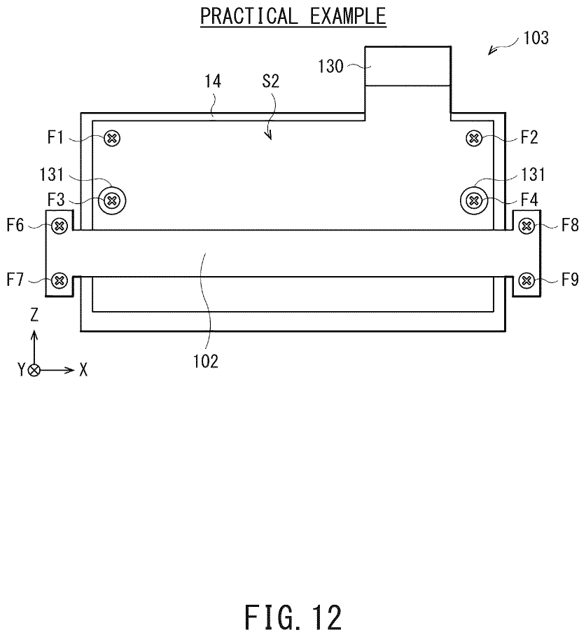

FIG. 12 is a plan view (a Z-X plan view) schematically showing a configuration example in the vicinity of a drive board (a flexible board 103) in an inkjet head according to the comparative example. In the vicinity of the flexible board 103 according to the comparative example, the fixation part 43 is not provided to a pressing member 102 unlike the pressing member 42 in the vicinity of the flexible board 13 in the present embodiment (see, e.g., FIG. 5 and FIG. 6). Therefore, in the inkjet head according to the comparative example, there is a possibility that the reliability is deteriorated for such a reason as described below.

Specifically, in the flexible board 103 in the comparative example, the drive devices 41 (the drive devices 411, 415) at both end sides the closest to fixation portions (fixation portions with the screws F6 to F9) in the vicinity of both ends in the pressing member 102 are pressed the most strongly against the cooling unit 14. On the other hand, regarding the drive device 413 located in the vicinity of the center along the X-axis direction, since the vicinity of the center along the X-axis direction in the pressing member 102 is deflected to make the force of pressing the drive device 413 against the cooling unit 14 insufficient in many cases. Further, since the two drive devices 412, 414 are arranged at the both ends of the drive device 413, the both ends are also affected by the heat generation of the surrounding drive devices 412, 414 in addition to the heat generation in operation of the drive device 413 itself, and are therefore the most thermally disadvantageous places. With all these factors, it can be said that a countermeasure of strongly pressing the drive device against the cooling unit 14 is necessary in the vicinity of the center along the X-axis direction in the pressing member 102 (in the vicinity of the drive device 413).

Here, an arrangement configuration example of the fixation part 43 described above will be described in detail with reference to FIG. 7 to FIG. 9 in addition to FIG. 4 to FIG. 6.

First, for example, the fixation part 43 (the through hole H15 and so on) is disposed in a region along the Z-axis direction with reference to the arrangement position of the drive device 413 which is the closest to a perpendicular bisector L5 with respect to a side (a long side) along the X-axis direction in the obverse surface S1 of the flexible board 13 out of the plurality of drive devices 41 arranged side by side along the X-axis direction (see FIG. 8 and FIG. 9). In particular, in the example in FIG. 9, the fixation part 43 (the through hole H15 and so on) is arranged in a region along the perpendicular bisector L5 with respect to the side (the long side) along the X-axis direction in the drive device 41 (the drive device 413) in the obverse surface S1 of the flexible board 13.

Further, for example, in the obverse surface S1 of the flexible board 13, the fixation part 43 (the through hole H15 and so on) is disposed in a region (an output terminal-side region Aout) including a wiring line of the drive signal Sd output from the drive device 41 (see FIG. 7). Advantages and so on in disposing the fixation part 43 (the through hole H15 and so on) in such an output terminal-side region Aout will hereinafter be described.

First, in the example in FIG. 10, there are shown an input terminal-side region Ain and the output terminal-side region Aout located on the periphery of each of the drive devices 41 (the drive devices 411 to 415) and inter-device regions Ag12, Ag23, Ag34, and Ag45 each located between the drive devices 41. It should be noted that the inter-device region Ag12 is a region located between the drive devices 411, 412, and the inter-device region Ag23 is a region located between the drive devices 412, 413. Similarly, the inter-device region Ag34 is a region located between the drive devices 413, 414, and the inter-device region Ag45 is a region located between the drive devices 414, 415.

Further, in the example in FIG. 11, there are shown the input terminal-side region Ain and the output terminal-side region Aout located on the periphery of each of the drive devices 412, 413 shown in FIG. 10, and the inter-device region Ag23 described above. FIG. 11 also shows a plurality of input terminals Tin and a plurality of output terminals Tout in each of the drive devices 412, 413, and a transmission line Lt which cascades these drive devices 412, 413. FIG. 11 further shows a variety of wiring patterns (patterns such as drive signal wiring lines Wd output from the respective output terminals Tout, a variety of power supply wiring lines Wp1, Wp2, and a ground wiring line Wg) and through holes TH for electrically coupling these wiring patterns to each other.

In the example in FIG. 11 having such a configuration, candidates of the arrangement position of the through hole H15 constituting the fixation part 43 include, for example, the following.
First Candidate: the input terminal-side region Ain.
Second Candidate: the inter-device region Ag23
Third Candidate: the output terminal-side region Aout

A variety of signal lines and components to be coupled to the input terminals Tin in the drive device 412, 413 are disposed in the input terminal-side region Ain as the first candidate. Meanwhile, the wiring patterns such as the variety of power supply wiring lines Wp1, Wp2 and the ground wiring line Wg are arranged in the inter-device region Ag23 as the second candidate (see FIG. 11).

Here, since the through hole H15 penetrates all the layers in the flexible board 13, the region with the components close together, the region with complicated wiring patterns, and the region where the variety of power supply wiring lines are arranged are not preferable as the arrangement position of the through hole H15. Further, since the portion around the through hole H15 is a portion where the pressing force applied by the pressing member 42 is the strongest, when such force is applied to the vicinity of a short side of the drive device 41 having a rectangular shape, there is a possibility that the coupling state between the flexible board 13 and the terminals of the drive device 41 is broken at that place.

Taking the above into consideration, it can be said that it is preferable to dispose the through hole H15 in the output terminal-side region Aout as the third candidate, namely in the vicinity of the center of a long side of the arrangement region of the drive device 41, out of the first through third candidates described above.

Further, in order to dispose the through hole H15 on the flexible board 13, it is necessary for a number of drive signal wiring lines Wd (see FIG. 11) disposed in the output terminal-side region Aout to be disposed so as to avoid the through hole H15. The more uniform an amount of the avoidance of the through hole H15 by these drive signal wiring lines Wd is in all the drive signal wiring lines Wd output from each of the drive devices 41, the more easily the drive signal wiring lines Wd are formed. Therefore, it can be said that the vicinity of the center in the long side direction (the X-axis direction) of the drive device 41 is preferable as the arrangement position of the through hole H15.

Further, when the plurality of drive devices 41 is disposed on the flexible board 13 as in the example in FIG. 10 and FIG. 11, for example, it is not required to dispose the through holes H15 in the respective output terminal-side regions Aout of the drive devices 41. As described above, the reason therefor is as follows. That is, first, regarding the drive device 413 located in the vicinity of the center along the X-axis direction, since the vicinity of the center along the X-axis direction in the pressing member 42 is deflected to weaken the force of pressing the drive device 413 against the cooling unit 14, and therefore, thermal contact with the cooling unit 14 is also weakened. Further, since the two drive devices 412, 414 are disposed at both ends of the drive device 413, the drive device 413 is in the most thermally disadvantageous place as described above. In order to solve these problems, it can be said that it is preferable to dispose a single through hole H15 in the output terminal-side region Aout of the drive device 413 in the vicinity of the center along the X-axis direction in the pressing member 42 (in the vicinity of the drive device 413).

Here, the X-axis direction described above corresponds to a specific example of a “first direction” in the present disclosure, and the Z-axis direction described above corresponds to a specific example of a “second direction” in the present disclosure. Further, the through hole H15 described above corresponds to a specific example of a “first through hole” in the present disclosure, and the through hole H25 described above corresponds to a specific example of a “second through hole” in the present disclosure. Further, the screw F5 described above corresponds to a specific example of a “fixation member” in the present disclosure.

### [Operations and Functions/Advantages]

### (A. Basic Operation of Printer 5)

In the printer 5, a recording operation (a printing operation) of images, characters, and so on to the recording target medium (the recording paper P or the like) is performed using such a jet operation of the ink 9 by the inkjet head 1 as described below. Specifically, in the inkjet head 1 according to the present embodiment, the jet operation of the ink 9 using a shear mode is performed in the following manner.

First, the drive devices 41 on each of the flexible boards 13 (13a, 13b, 13c, and 13d) each apply the drive voltages Vd (the drive signals Sd) to the drive electrodes (the common electrodes and the active electrodes) described above in the actuator plate 111 in the jet section 11. Specifically, each of the drive devices 41 applies the drive voltage Vd to the drive electrodes disposed on the pair of drive walls partitioning the ejection channel described above. Thus, the pair of drive walls each deform so as to protrude toward the dummy channel adjacent to the ejection channel.

On this occasion, it results in that the drive wall makes a flexion deformation to have a V shape centering on the intermediate position in the depth direction in the drive wall. Further, due to such a flexion deformation of the drive wall, the ejection channel deforms as if the ejection channel bulges. As described above, due to the flexion deformation caused by a piezoelectric thickness-shear effect in the pair of drive walls, the volume of the ejection channel increases. Further, by the volume of the ejection channel increasing, the ink 9 is induced into the ejection channel as a result.

Subsequently, the ink 9 induced into the ejection channel in such a manner turns to a pressure wave to propagate to the inside of the ejection channel. Then, the drive voltage Vd to be applied to the drive electrodes becomes 0 (zero) V at the timing at which the pressure wave has reached the nozzle hole Hn of the nozzle plate 112 (or timing around that timing). Thus, the drive walls are restored from the state of the flexion deformation described above, and as a result, the volume of the ejection channel having once increased is restored again.

In such a manner, the pressure inside the ejection channel increases in the process that the volume of the ejection channel is restored, and thus, the ink 9 in the ejection channel is pressurized. As a result, the ink 9 shaped like a droplet is ejected (see FIG. 1) toward the outside (toward the recording paper P) through the nozzle hole Hn. The jet operation (the ejection operation) of the ink 9 in the inkjet head 1 is performed in such a manner, and as a result, the recording operation of images, characters, and so on to the recording paper P is performed.

### (B. Functions/Advantages in Inkjet Head 1)

Then, the functions and the advantages in the inkjet head 1 according to the present embodiment will be described in detail.

### (B-1. Regarding Related-Art Inkjet Head)

First, in general, the drive board for driving the inkjet head (the drive board on which the drive devices are mounted) is extremely large in the number of wiring lines related to input and output of the drive device. Therefore, in order to arrange the wiring lines for radiating heat of the drive device and so on, it is arranged that the number of layers of the board is increased, and the broad wiring lines (the ground wiring line and the power supply wiring lines) for radiating the heat are disposed on those layers. However, the number of layers can easily be increased in a rigid board, but it is difficult to increase the number of layers in the flexible board in terms of cost.

Further, in recent years, since the number of driving nozzles of the inkjet head increases, and the ejection frequency also rises, an amount of heat generated in the drive devices increases in addition to an increase in mounting density of the drive devices. Therefore, the wiring lines for radiating the heat arranged on the drive board cannot sufficiently radiate the heat of the drive devices. Therefore, it results in that the heat radiation of the drive devices is performed with, for example, a cooling member (a heatsink or the like) using metal. It has been known that, for example, such a cooling member is screwed to an area between a plurality of drive devices to ensure the heat radiation path in order to ensure a thermal contact between the cooling member and the drive devices.

When screwing the cooling member in the area between the drive devices in such a manner, it becomes necessary for the area (gap) between the drive devices to be larger than the screw, but in consideration of the circuit mounting density on the board, the smaller the gap between the drive devices, the more preferable. Further, it is necessary to dispose the screw hole in the area of that small gap. In other words, the request of increasing the circuit mounting density and the request of ensuring the gap for screwing contradict each other. This problem becomes more conspicuous in particular when the plurality of drive devices each having a rectangular shape is arranged side by side along the long side, and moreover, there is also a problem that when the plurality of drive devices is arranged side by side, the thermal contact with the drive device disposed in the vicinity of the center becomes difficult.

With all these factors, it can be said that in the related-art inkjet head, there is a possibility that the reliability is deteriorated.

### (B-2. Functions/Advantages)

In contrast, in the inkjet head 1 according to the present embodiment, since the following configuration is adopted, it is possible to obtain, for example, the following functions and advantages.

That is, first, in the inkjet head 1, the pressing member 42 for pressing the flexible board 13 against the cooling unit 14 is disposed at the reverse surface S2 side (the side of the surface opposed to the obverse surface S1 side on which the cooling unit 14 for cooling the drive devices 41 is disposed) of the flexible board 13. Further, the inkjet head 1 is provided with the fixation part 43 which fixes a part of the pressing member 42 to the flexible board 13. Thus, in the present embodiment, since the pressing force on the drive devices 41 on the flexible board 13 against the cooling unit 14 becomes easier to ensure compared to the comparative example described above, cooling of the drive devices 41 is promoted, and as a result, the stability of operations of the drive devices 41 is ensured.

Further, in this inkjet head 1, the arrangement area of the drive devices 41 on the flexible board 13 extends along the X-axis direction in the obverse surface S1. Further, with reference to the arrangement position of the drive devices 41, the fixation part 43 is disposed in a region along the Z-axis direction perpendicular to the X-axis direction in the obverse surface S1 on the flexible board 13. Thus, in the present embodiment, the following is achieved unlike when, for example, the fixation part 43 is disposed in a region along the X-axis direction with reference to the arrangement position of the drive devices 41. That is, a failure (a coupling failure between the terminals of the drive devices 41 and the flexible board 13, or the like) in the vicinity of the end portion in the X-axis direction in the drive devices 41 is avoided.

This makes it possible to improve the reliability of the inkjet head 1 in the present embodiment compared to, for example, the comparative example described above.

Further, in the present embodiment, since it is also prevented that the strong force due to the screw F5 is applied to the flexible board 13 in the vicinity of the end portion of the drive devices 41, and the coupling between the terminals in the vicinity of the end portion of the drive devices and the flexible board 13 is broken, it becomes possible to improve the reliability in this regard. Further, when the plurality of drive devices 41 is disposed, since it is possible to efficiently obtain the advantage described above with a small number of through holes (one through hole H15), it becomes possible to reduce the cost. In addition, in the present embodiment, since high-frequency ejection becomes possible, the productivity of the printer 5 is enhanced, and it becomes easy to ensure the return lines of the drive signals Sd output from the drive devices 41, and therefore, it becomes possible to obtain the advantages described above while ensuring the reliability. Further, in the present embodiment, by providing the flexible board 13 with such a configuration, it is possible to dispose appropriate through holes in accordance with, for example, the size and the number of the drive devices 41, and therefore, it becomes possible to achieve the improvement of the reliability and the reduction in cost while ensuring the degree of design freedom of the inkjet head 1.

Further, in the present embodiment, since the plurality of drive devices 41 is arranged side by side along the X-axis direction in the arrangement area of the drive devices 41, the following is achieved. That is, since the drive devices 41 are arranged along the longitudinal direction, the paths of the wiring patterns on the flexible board 13 become short and simple. Therefore, it becomes possible to achieve the reduction in size of the flexible board 13.

In addition, in the present embodiment, when it is arranged that the fixation part 43 is disposed in the region along the Z-axis direction with reference to the arrangement position of the drive device 413 which is the closest to the perpendicular bisector L5 with respect to the side along the X-axis direction in the obverse surface S1 of the flexible board 13 out of the plurality of drive devices 41 arranged side by side along the X-axis direction, the following is achieved. That is, by adopting such an arrangement of the fixation part 43 (the through hole H15), it is possible to dispose the through hole H15 only in the vicinity of the center of the flexible board 13 large in unevenness of thermal distribution, and thus, it becomes possible to decrease the number of necessary members and through holes.

Further, since in the present embodiment, the number of drive devices 41 on the flexible board 13 is an odd number (five), the following is achieved. That is, when the number of drive devices 41 is an odd number, it is possible to obtain the advantages described above while keeping the number of through holes (through hole H15) to be added due to the provision of the fixation part 43 to one. As a result, it becomes possible to achieve the improvement of the reliability and the reduction of the cost while ensuring the degree of design freedom of the inkjet head 1.

Further, in the present embodiment, when it is arranged that the fixation part 43 is arranged in the region along the perpendicular bisector L5 with respect to the side along the X-axis direction in the drive device 41 in the obverse surface S1 of the flexible board 13, the following is achieved. That is, by adopting such an arrangement of the fixation part 43 (the through hole H15), it is possible to cool the vicinity of the center of the drive device 41 with the cooling unit 14, and therefore, it is possible to reduce the unevenness in the thermal distribution in the drive device 41. In addition, it is possible to prevent the vicinity of end portion of the drive device 41 from cracking by a force of pressing from the fixation part 43. As a result, it becomes possible to improve the reliability of the flexible board 13 itself.

In addition, in the present embodiment, when, in the obverse surface S1 of the flexible board 13, it is arranged that the fixation part 43 is disposed in a region (the output terminal-side region Aout) including the wiring line of the drive signal Sd output from the drive device 41, the following is achieved. That is, by disposing the fixation part 43 (the through hole H15) in a region avoiding the region in which the lines for the drive power supply and the components on the periphery of the drive device 41 are disposed, it becomes easy to achieve the wiring arrangement for avoiding the through hole H15. Thus, it is possible to form the flexible board 13 in which the through hole H15 is disposed while ensuring the stable operation of the drive device 41, and therefore, it becomes possible to further improve the reliability of the inkjet head 1.

Further, since in the present embodiment, the fixation part 43 is configured including the through hole H15 disposed on the flexible board 13, the through hole H25 disposed on the pressing member 42, and the fixation members (the screws F5) which are inserted into each of the through holes H15 and H25 and are configured to fix the flexible board 13 and the pressing member 42 to each other, the following is achieved. That is, even when, for example, the drive device 41 is distant from the end portion of the flexible board 13, it becomes possible to surely press the arrangement area of the drive device 41 against the cooling unit 14 to surely fix the pressing member 42.

Further, since in the present embodiment, the electrical contact part 131 between the flexible board 13 and the screw F5 is not disposed on the periphery of the through hole H15 constituting the fixation part 43, the following is achieved. That is, it is possible to reduce the arrangement area of the components and the wiring lines avoiding the through hole H15 on the flexible board 13, and thus, it is possible to achieve the arrangement of the power supply lines and the components which makes a contribution to the stable operation of the inkjet head 1.

In addition, since in the present embodiment, it is arranged that the drive board for driving the inkjet head 1 is formed of the flexible board 13, the following is achieved. That is, it is possible to improve the degree of design freedom and an assembling property of the inkjet head 1, and thus, it is possible to achieve the reduction in size of the inkjet head 1 and the increase in yield ratio.

### 2. MODIFIED EXAMPLES

Then, some modified examples (Modified Example 1 and Modified Example 2) of the embodiment described above will be described. It should be noted that the same constituents as those in the embodiment are denoted by the same reference symbols, and the description thereof will be omitted as appropriate.

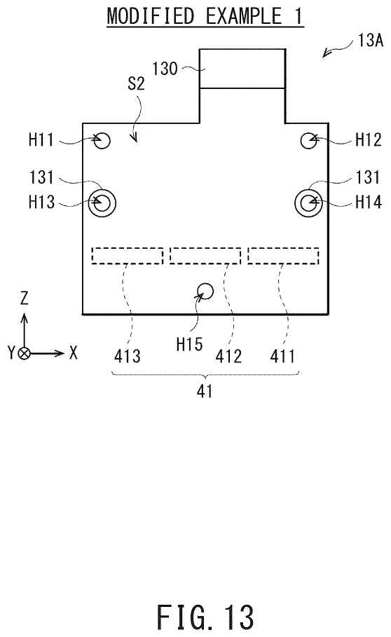

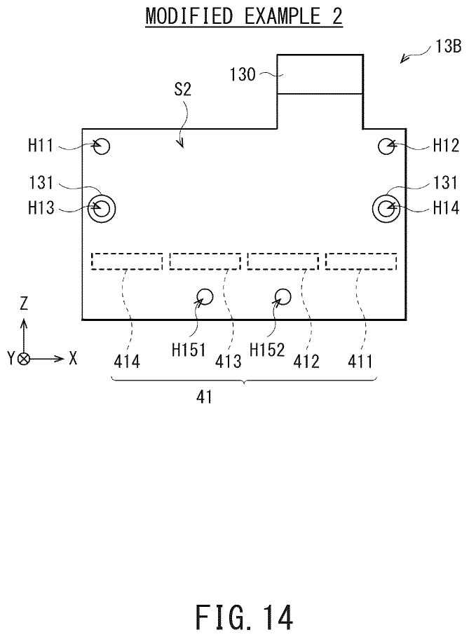

FIG. 13 is a plan view (a Z-X plan view) schematically showing a configuration example in the vicinity of a flexible board (a flexible board 13A) related to Modified Example 1. Further, FIG. 14 is a plan view (a Z-X plan view) schematically showing a configuration example in the vicinity of a flexible board (a flexible board 13B) related to Modified Example 2.

The flexible boards 13A, 13B in Modified Examples 1, 2 are made different in the number of drive devices 41 from the flexible board 13 in the embodiment, and are made substantially the same in other configurations. Specifically, in the flexible board 13A in Modified Example 1 shown in FIG. 13, three (an odd number of) drive devices 411 to 413 are arranged side by side along the X-axis direction. On the other hand, in the flexible board 13B in Modified Example 2 shown in FIG. 14, four (an even number of) drive devices 411 to 414 are arranged side by side along the X-axis direction.

Here, in the flexible board 13A in Modified Example 1, similarly to the case of the flexible board 13 in the embodiment, the through hole H15 constituting the fixation part 43 is disposed in the following region. That is, the through hole H15 constituting the fixation part 43 is disposed in a region (the output terminal-side region Aout described above) along the Z-axis direction with reference to the arrangement position of the drive device 412 which is the closest to the perpendicular bisector with respect to the side along the X-axis direction.

Here, in the flexible board 13A in Modified Example 1, similarly to the case of the flexible board 13 in the embodiment, the through hole H15 constituting the fixation part 43 is disposed as follows. That is, the single through hole H15 constituting the fixation part 43 is disposed in the region (the output terminal-side region Aout described above) along the Z-axis direction with reference to the arrangement position of the single drive device 412 which is the closest to the perpendicular bisector with respect to the side along the X-axis direction.

Meanwhile, in a flexible board 13B in Modified Example 2, slightly different from the case of the flexible board 13 in the embodiment, the through hole H15 constituting the fixation part 43 is disposed as follows. That is, two through holes H151, H152 constituting the fixation part 43 are respectively disposed in the regions (the output terminal-side regions Aout described above) along the Z-axis direction with reference to the arrangement positions of the two drive devices 412, 413 which are the closest to the perpendicular bisector with respect to the side along the X-axis direction. It should be noted that it is arranged that the electrical contact part 131 described above is not disposed on the periphery of these through holes H151, H152 similarly to the periphery of the through hole H15. Further, both the through holes H151, H152 may be disposed, or it is possible to arrange that only either one of the through holes H151, H152 is disposed alone.

In this way, it is arranged that the configuration and the arrangement area of the fixation part 43 are set in accordance with whether the number of drive devices 41 is an odd number or an even number.

It should be noted that each of the flexible boards 13A, 13B corresponds to a specific example of a “drive board” in the present disclosure. Further, each of the through holes H151, H152 corresponds to a specific example of a “first through hole” in the present disclosure.

In Modified Examples 1, 2 having such configurations, it is also possible to obtain basically the same advantages due to substantially the same function as that of the embodiment.

### 3. OTHER MODIFIED EXAMPLES

The present disclosure is described hereinabove citing the embodiment and the modified example, but the present disclosure is not limited to the embodiment and so on, and a variety of modifications can be adopted.

For example, in the embodiment and so on described above, the description is presented specifically citing the configuration examples (the shapes, the arrangements, the number and so on) of each of the members in the printer and the inkjet head, but those described in the above embodiment and so on are not limitations, and it is possible to adopt other shapes, arrangements, numbers and so on.

Specifically, for example, in the embodiment and so on described above, the description is presented specifically citing the configuration examples (the shapes, the arrangement, the number, and so on) of the flexible boards, the drive devices, the fixation parts, a variety of wiring patterns, and so on, but these configuration examples are not limited to those described in the above embodiment and so on. For example, in the embodiment and so on described above, there is described the example when the plurality of drive boards is disposed inside the inkjet head, but this example is not a limitation, and it is possible to arrange that, for example, just one drive board is disposed alone inside the inkjet head. Further, in the embodiment and so on described above, there is described the example when the plurality of drive devices is disposed on the drive board, but this example is not a limitation, and it is possible to arrange that, for example, just one drive device is disposed on the drive board. Further, in the embodiment and so on described above, the example when the drive board is the flexible board is described, but this example is not a limitation, and the drive board can also be, for example, an inflexible board (a rigid board). In addition, in the embodiment and so on described above, the shape of the drive device is assumed to be the rectangular shape, but this example is not a limitation, and the shape of the drive device can be, for example, a square shape. Further, in the above embodiment and so on, the description is presented citing the screw as a specific example of the “fixation member” in the present disclosure, but this example is not a limitation, and it is also possible to configure the “fixation member” using other members (e.g., a pin of a pin badge or a dowel).

Further, a variety of types of structures can be adopted as the structure of the inkjet head. Specifically, it is possible to adopt, for example, a so-called side-shoot type inkjet head which ejects the ink 9 from a central portion in the extending direction of each of the ejection channels in the actuator plate 111. Alternatively, it is possible to adopt, for example, a so-called edge-shoot type inkjet head for ejecting the ink 9 along the extending direction of each of the ejection channels. Further, the type of the printer is not limited to the type described in the above embodiment and so on, and it is possible to apply a variety of types such as a micro electro-mechanical systems (MEMS) type.

Further, for example, it is possible to apply the present disclosure to either of an inkjet head of a circulation type which uses the ink 9 while circulating the ink 9 between the ink tank and the inkjet head, and an inkjet head of a non-circulation type which uses the ink 9 without circulating the ink 9.

Further, the series of processing described in the above embodiments and so on can be arranged to be performed by hardware (a circuit), or can also be arranged to be performed by software (a program). When it is arranged that the series of processing is performed by the software, the software is constituted by a program group for making the computer perform the functions. The programs can be incorporated in advance in the computer described above to be used by the computer, for example, or can also be installed in the computer described above from a network or a recording medium to be used by the computer.

Further, in the embodiment and so on described above, the description is presented citing the printer 5 (the inkjet printer) as a specific example of the “liquid jet recording apparatus” in the present disclosure, but this example is not a limitation, and it is also possible to apply the present disclosure to other apparatuses than the inkjet printer. In other words, it is also possible to arrange that the “liquid jet head” (the inkjet head) of the present disclosure is applied to other apparatuses than the inkjet printer. Specifically, it is also possible to arrange that the “liquid jet head” of the present disclosure is applied to an apparatus such as a facsimile or an on-demand printer.

In addition, it is also possible to apply the variety of examples described hereinabove in arbitrary combination.

It should be noted that the advantages described in the present specification are illustrative only, but are not a limitation, and other advantages can also be provided. Further, the present disclosure can also take the following configurations.

A liquid jet head including a jet section including a plurality of nozzles configured to jet a liquid, a drive board having a first surface on which a single drive device or a plurality of drive devices for outputting a drive signal for jetting the liquid from the nozzles to the jet section is disposed, a heat radiation member which is disposed at the first surface side in the drive board, and which is configured to cool the drive device, a pressing member which is disposed at a second surface side opposed to the first surface in the drive board, and which is configured to press the drive board against the heat radiation member, and a fixation part configured to fix a part of the pressing member to the drive board, wherein an arrangement area of the drive device extends along a first direction in the first surface, and the fixation part is disposed in a region along a second direction perpendicular to the first direction in the first surface with reference to an arrangement position of the drive device.

The liquid jet head described in (1) above, wherein the plurality of drive devices is arranged side by side along the first direction in the arrangement area of the drive devices.

The liquid jet head described in (2) above, wherein the fixation part is disposed in a region along the second direction with reference to the arrangement position of the single drive device or the plurality of drive devices closest to a perpendicular bisector with respect to a side along the first direction in the first surface of the drive board out of the plurality of drive devices arranged side by side along the first direction.

The liquid jet head described in (3) above, wherein the number of drive devices is an odd number.

The liquid jet head described in any one of (1) to (4) above, wherein the fixation part is disposed in a region along a perpendicular bisector with respect to a side along the first direction in the drive device in the first surface.

The liquid jet head described in (5) above, wherein the fixation part is disposed in a region including a wiring line of the drive signal output from the drive device in the first surface.

The liquid jet head described in any one of (1) to (6) above, wherein the fixation part is configured to include a first through hole disposed on the drive board, a second through hole disposed on the pressing member, and a fixation member which is inserted into each of the first through hole and the second through hole, and which is configured to fix the drive board and the pressing member to each other.

The liquid jet head described in (7) above, wherein an electrical contact part between the drive board and the fixation member is not disposed on a periphery of the first through hole.

The liquid jet head described in any one of (1) to (8) above, wherein the drive board is a flexible board.

A liquid jet recording apparatus including the liquid jet head described in any one of (1) to (9) above.

What is claimed is:

1. A liquid jet head comprising:
a jet section including a plurality of nozzles configured to jet a liquid;
a drive board having a first surface on which a single drive device or a plurality of drive devices for outputting a drive signal for jetting the liquid from the nozzles to the jet section is disposed;
a heat radiation member which is disposed at the first surface side in the drive board, and which is configured to cool the drive device;
a pressing member which is disposed at a second surface side opposed to the first surface in the drive board, and which is configured to press the drive board against the heat radiation member; and
a fixation part configured to fix a part of the pressing member to the drive board, wherein
an arrangement area of the drive device extends along a first direction in the first surface, and
the fixation part is disposed in a region along a second direction perpendicular to the first direction in the first surface with reference to an arrangement position of the drive device.

2. The liquid jet head according to claim 1, wherein
the plurality of drive devices is arranged side by side along the first direction in the arrangement area of the drive devices.

3. The liquid jet head according to claim 2, wherein
the fixation part is disposed in a region along the second direction with reference to the arrangement position of the single drive device or the plurality of drive devices closest to a perpendicular bisector with respect to a side along the first direction in the first surface of the drive board out of the plurality of drive devices arranged side by side along the first direction.

4. The liquid jet head according to claim 3, wherein
the number of drive devices is an odd number.

5. The liquid jet head according to claim 1, wherein
the fixation part is disposed in a region along a perpendicular bisector with respect to a side along the first direction in the drive device in the first surface.

6. The liquid jet head according to claim 5, wherein
the fixation part is disposed in a region including a wiring line of the drive signal output from the drive device in the first surface.

7. The liquid jet head according to claim 1, wherein
the fixation part is configured to include
a first through hole disposed on the drive board,
a second through hole disposed on the pressing member, and
a fixation member which is inserted into each of the first through hole and the second through hole, and which is configured to fix the drive board and the pressing member to each other.

8. The liquid jet head according to claim 7, wherein
an electrical contact part between the drive board and the fixation member is not disposed on a periphery of the first through hole.

9. The liquid jet head according to claim 1, wherein
the drive board is a flexible board.

10. A liquid jet recording apparatus comprising the liquid jet head according to claim 1.
